(19) United States
(12) Patent Application Publication
(10) Pub. No.: US 2017/0134090 A1
(43) Pub. Date: May 11, 2017

(54) HANDHELD TERMINALS, COMPUTERS, AND VISIBLE LIGHT COMMUNICATION SYSTEMS

(71) Applicant: JRD COMMUNICATION INC., Shenzhen, Guangdong (CN)

(72) Inventors: Shiqing Zhao, Shenzhen, Guangdong (CN); Xuelong Ronald Hu, Shenzhen, Guangdong (CN); George Guo, Shenzhen, Guangdong (CN)

(73) Assignee: JRD COMMUNICATION INC., Shenzhen, Guangdong (CN)

(21) Appl. No.: 15/104,227

(22) PCT Filed: Jul. 31, 2015
(86) PCT No.: PCT/CN2015/085723

§ 371 Date: Jun. 13, 2016

(30) Foreign Application Priority Data
Mar. 26, 2015 (CN) 2015 10138055.3

(51) Int. Cl. H04B 10/116; H04M 1/725; H04M 1/737

(52) U.S. Cl. CPC H04B 10/116; H04M 1/737; H04M 1/7253

(57) ABSTRACT

A handheld terminal, a computer and a visible light communication system are disclosed. In the handheld terminal, a first backlight apparatus is disposed on a display screen of the handheld terminal, a first data processing apparatus accesses data from a first data storage apparatus and converts the data to multiple luminance level control signals that are used to control the luminance level of the first backlight apparatus, a first control apparatus controls the first backlight apparatus to adjust its current luminance based on the multiple luminance level control signals, and the first backlight apparatus changes its luminance in accordance with the change of the data and, as a result, transmits the data to the computer in the form of visible light. Thus, the present disclosure eliminates the need of cumbersome physical connection ports and intermediate connection cables, and enables stable, reliable and highly secure visible light communications.

### FIELD OF THE DISCLOSURE

The present disclosure relates to communication technologies, and more particularly, to a handheld terminal, a computer, and a visible light communication system.

### BACKGROUND OF THE DISCLOSURE

A USB (universal serial bus) port is generally used for data transmission between a computer and a terminal such as a mobile phone. The USB port communication typically requires a USB cable to be connected between the computer and the terminal, resulting in cumbersome USB cables. In addition, when a USB cable is not at hand, the connection and communication cannot be enabled.

### SUMMARY OF THE DISCLOSURE

A principal technical problem to be addressed by the disclosure is to provide a handheld terminal, a computer and a visible light communication system, thereby eliminating the need of cumbersome physical ports and connection cables, and enabling stable, reliable and highly secure visible light communications.

One technical solution adopted by the disclosure is to provide a handheld terminal for data transmission with a computer. The handheld terminal includes a first backlight apparatus, a first control apparatus, a first data processing apparatus, and a first data storage apparatus. The first backlight apparatus is disposed on a display screen of the handheld terminal. The first data storage apparatus is stored with data. The first data processing apparatus may access the data from the first data storage apparatus, and convert the data to multiple luminance level control signals that are used to control the luminance of the first backlight apparatus. The first control apparatus may control the first backlight apparatus to adjust its current luminance according to the multiple luminance level control signals. The first backlight apparatus thus may change its luminance in accordance with change of the data, and transmit the data to the computer in the form of visible light.

The handheld terminal may include a visible light receiver configured to receive visible light.

The visible light receiver may be disposed on a border of the display screen.

The visible light receiver may be disposed near a front camera of the handheld terminal, and thus form a combination with the front camera.

The first backlight apparatus may employ an LED (light-emitting diode) light source.

To achieve the above objectives, another technical solution adopted by the disclosure is to provide a computer for data transmission with a handheld terminal. The computer includes a second backlight apparatus, a second control apparatus, a second data processing apparatus and a second data storage apparatus. The second backlight apparatus is disposed on a display screen of the computer. The second data storage apparatus is configured to store data. The second data processing apparatus may access the data from the second data storage apparatus, and convert the data to multiple luminance level control signals that are used to control the luminance of the second backlight apparatus. The second control apparatus may control the second backlight apparatus to adjust its current luminance according to the multiple luminance level control signals. The second backlight apparatus thus may change its luminance in accordance with change of the data, and transmit the data to the handheld terminal in the form of visible light.

The second backlight apparatus may employ an LED (light-emitting diode) backlight source.

The computer may further include a photosensitive sensor configured to receive visible light data.

The photosensitive sensor may be disposed at the upper part of a border of the display screen of the computer.

To achieve the above objectives, yet another technical solution adopted by the disclosure is to provide a visible light communication system including a handheld terminal and a computer. The handheld terminal performs data transmission with the computer, and includes a first backlight apparatus, a first control apparatus, a first data processing apparatus and a first data storage apparatus. The first backlight apparatus is disposed on a display screen of the handheld terminal. The first data storage apparatus is stored with data. The first data processing apparatus may access the data from the first data storage apparatus, and convert the data to multiple luminance level control signals that are used to control the luminance of the first backlight apparatus. The first control apparatus may control the first backlight apparatus to adjust its current luminance based on the multiple luminance level control signals. The first backlight apparatus thus may change its luminance in accordance with change of the data, and transmit the data to the computer in the form of visible light. The computer performs data transmission with the handheld terminal, and includes a second backlight apparatus, a second control apparatus, a second data storage apparatus and a second data processing apparatus. The second backlight apparatus is disposed on a display screen of the computer. The second data storage apparatus is configured to store data. The second data processing apparatus may access the data from the second data storage apparatus, and convert the data to multiple luminance level control signals that are used to control the luminance of the second backlight apparatus. The second control apparatus may control the second backlight apparatus to adjust its current luminance according to the multiple luminance level control signals. The second backlight apparatus thus may change its luminance in accordance with change of the data, and transmit the data to the handheld terminal in the form of visible light.

The handheld terminal may include a visible light receiver configured to receive visible light.

The visible light receiver may be disposed on a border of the display screen of the handheld terminal.

The visible light receiver may be disposed near a front camera of the handheld terminal, and thus form a combination with the front camera.

The first backlight apparatus may employ an LED (light-emitting diode) light source.

The second backlight apparatus may employ an LED (light-emitting diode) backlight source.

The computer may further include a photosensitive sensor configured to receive visible light data.

The photosensitive sensor may be disposed at the upper part of a border of the display screen of the computer.

The disclosure may have the following advantages over the prior art. According to the disclosure, the first data processing apparatus converts the data to multiple luminance level control signals that are used to control the luminance of the first backlight apparatus, the first control apparatus controls the first backlight apparatus to adjust its current luminance according to the multiple luminance level control signals. And, the first backlight apparatus, disposed on the display screen of the handheld terminal, can change its luminance in accordance with change of the data, and thus can send the data to the computer as visible light. Thus, the disclosure can eliminate the need of cumbersome physical connection ports and connection cables, and can achieve stable, reliable and highly secure visible light communications.

### BRIEF DESCRIPTION OF THE DRAWINGS

FIG. 1 is a schematic diagram of a visible light communication system according to an embodiment of the disclosure.

FIG. 2 is a block diagram of a handheld terminal according to an embodiment of the disclosure.

FIG. 3 is a block diagram of a computer according to an embodiment of the disclosure.

### DETAILED DESCRIPTION OF THE DISCLOSURE

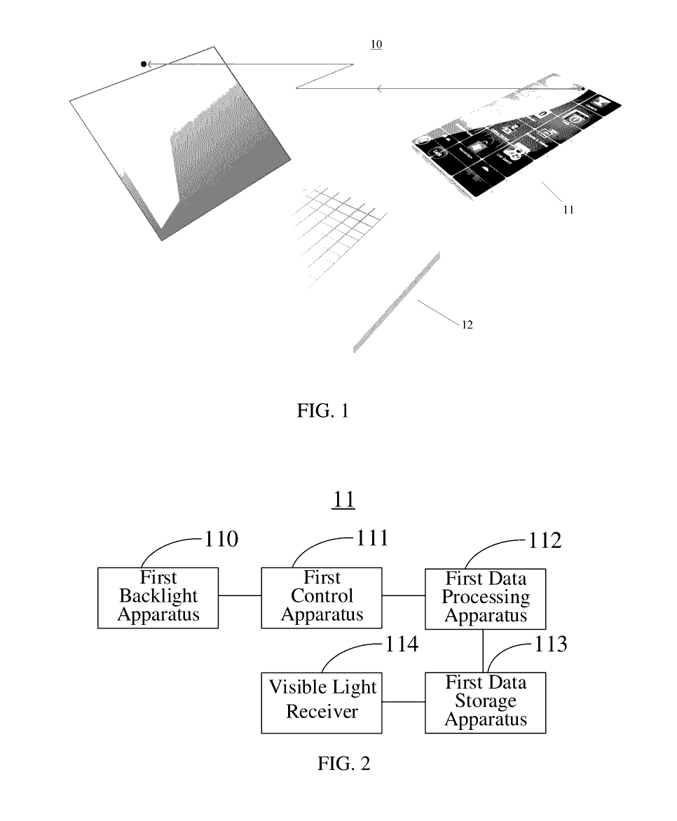

Referring to FIG. 1, which shows a visible light communication system according to an embodiment. The visible light communication system 10 includes a handheld terminal 11 and a computer 12 having a display screen. The display screen of the computer 12 may include an LED (light-emitting diode) backlight source which serves as a transmitter for emitting data. The computer 12 may further include a photosensitive sensor configured to receive visible light data. Similarly, the handheld terminal 11 may include a visible light receiver configured to receive visible light data, and a display screen of the handheld terminal 11 may include an LED backlight source which also serves as a transmitter for emitting data. Thus, the need of cumbersome physical connection ports, such as the USB port, or other intermediate connection cables can be eliminated, and the visible light can be used for data transmission between the computer and the handheld terminal.

Referring also to FIG. 2, there is shown a block diagram of a handheld terminal according to an embodiment. The handheld terminal 11 includes a first backlight apparatus 110, a first control apparatus 111, a first data processing apparatus 112, a first data storage apparatus 113, and a visible light receiver 114. The handheld terminal 11 may perform data transmission with the computer 12. The first backlight apparatus 110 may be disposed on a display screen of the handheld terminal 11. The first data storage apparatus 113 may be stored with data. The first data processing apparatus 112 may access data from the first data storage apparatus 113, and convert the data to multiple luminance level control signals that are used to control the luminance of the first backlight apparatus 110. The first control apparatus 111 may utilize the multiple luminance level control signals to control the first backlight apparatus 110 to adjust its current luminance. Thus, the first backlight apparatus 110 can change its luminance along with change of the data. As a result, the data can be transmitted to the computer 12 in the form of visible light.

The first backlight apparatus 110 may employ an LED backlight source. The backlight LEDs can be used to transmit the data of the handheld terminal 11, i.e., the data can be carried onto the visible light emitted from the backlight LEDs, and thus be transmitted. The handheld terminal 11 may transfer the data to be emitted to the LED backlight apparatus of the handheld terminal 11. The data may be modulated onto the light emitted by the backlight LEDs, and thus be emitted in the form of visible light.

The handheld terminal 11 can include a visible light receiver 114 disposed at an appropriate position on a border of the display screen of the handheld terminal 11. The visible light receiver 114 is configured to receive visible light data, and may be a photosensitive device, such as a phototriode. The visible light receiver 114 may be disposed at a position where light can be easily received. Typically, the visible light receiver 114 can be disposed on a border of the display screen, such as on the upper part, middle part or lower part of the screen border. The visible light receiver 114 can also be disposed near a front camera of the handheld terminal 110, such that the visible light receiver 114 can form a combination with the front camera, which thus provides a more aesthetic and compact design.

According to the current embodiment, the handheld terminal 11 includes a first backlight apparatus 110 which transmits visible light data to the computer, and also a visible light receiver 114 which receives visible light data, such that the need of physical connection medium, such as the USB port or USB cable, can be eliminated, and visible light communications can be enabled for data transmission with the computer with high stability, reliability, and security.

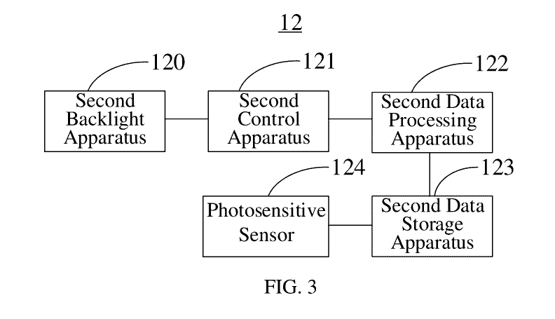

Referring now to FIG. 3, the computer 12 includes a second backlight apparatus 120, a second control apparatus 121, a second data storage apparatus 122, a second data processing apparatus 123 and a photosensitive sensor 124. The computer 12 may perform data transmission with the handheld terminal 11. The second backlight apparatus 120 may be disposed on a display screen of the computer 12. The second data storage apparatus 122 may be configured to store data. The second data processing apparatus 123 may access the data from the second data storage apparatus 122, and convert the data to multiple luminance level control signals that are used to control the luminance of the second backlight apparatus 120. The second control apparatus 121 may utilize the multiple luminance level control signals to control the second backlight apparatus 120 to adjust its current luminance. Thus, the second backlight apparatus 120 may change its luminance along with the change of the data. As a result, the data can be transmitted to the handheld terminal 11 in the form of visible light.

The second backlight apparatus 120 may employ an LED backlight source. The backlight LEDs may be used to transmit the data of the computer 12. The backlight LEDs can be disposed on the display screen of the computer 12. The computer 12 may transfer the data to be emitted to the LED backlight apparatus. The data may be modulated onto the light emitted from the backlight LEDs, and thus be emitted in the form of visible light.

The photosensitive sensor 124 may be configured to receive visible light data. The computer 12 may further include a visible light photosensitive sensor disposed at an appropriate position on a border of its display screen to receive visible light data. Typically, the visible light photosensitive sensor can be a visible light receiver, such as a phototriode. The photosensitive sensor 124 may be disposed at a position where light can be easily received. Typically, the photosensitive sensor 124 may be disposed at an upper part of a border of the display screen of the computer 12. Most existing computers set the camera at this position. The photosensitive sensor 124 may also be disposed near the front camera and thus form a combination with the front camera.

According to the current embodiment, the computer 12 includes a second backlight apparatus 120 which transmits visible light data to the handheld terminal, and a photosensitive sensor 124 which receives visible light data, such that the need of physical connection medium, such as the USB port or USB cable, can be eliminated, and visible light communications can be enabled to perform data transmission with the handheld terminal with high stability, reliability, and security.

In conclusion, the first data processing apparatus accesses and converts the data to multiple luminance level control signals that are used to control the luminance of the first backlight apparatus, the first control apparatus controls the first backlight apparatus to adjust its current luminance according to the multiple luminance level control signals. And, the first backlight apparatus, disposed on the display screen of the handheld terminal, can change its luminance in accordance with the change of data, and thus can transmit the data to the computer in the form of visible light. Thus, the disclosure can eliminate the need of cumbersome physical connection ports and connection cables, and can achieve stable, reliable and highly secure visible light communications.

The above description is merely embodiments of the disclosure, but is not limiting the scope of the disclosure. Any equivalent structures or flow transformations made relying on the disclosure, or any direct or indirect applications of the disclosure on other related fields, shall all be covered within the protection of the disclosure.

1. A handheld terminal configured to perform data transmission with a computer, comprising a first backlight apparatus, a first control apparatus, a first data processing apparatus, and a first data storage apparatus, wherein the first backlight apparatus is disposed on a display screen of the handheld terminal, the first data storage apparatus is stored with data, the first data processing apparatus accesses the data from the first data storage apparatus and converts the data to a plurality of luminance level control signals that are configured to control the luminance of the first backlight apparatus, the first control apparatus controls the first backlight apparatus to adjust its current luminance based on the plurality of luminance level control signals, and the first backlight apparatus changes its luminance in accordance with change of the data and transmits the data to the computer in the form of visible light.

2. The handheld terminal according to claim 1, further comprising a visible light receiver configured to receive visible light data.

3. The handheld terminal according to claim 2, wherein the visible light receiver is disposed on a border of the display screen of the handheld terminal.

4. The handheld terminal according to claim 2, wherein the visible light receiver is disposed adjacent to a front camera of the handheld terminal and thus forms a combination with the front camera.

5. The handheld terminal according to claim 1, wherein the first backlight apparatus employs a light-emitting diode (LED) light source.

6. A computer configured to perform data transmission with a handheld terminal, comprising a second backlight apparatus, a second control apparatus, a second data storage apparatus and a second data processing apparatus, wherein the second backlight apparatus is disposed on a display screen of the computer, the second data storage apparatus is configured to store data, the second data processing apparatus accesses and converts the data to a plurality of luminance level control signals that are used to control the luminance of the second backlight apparatus, the second control apparatus controls the second backlight apparatus to change its current luminance based on the plurality of luminance level control signals, and the second backlight apparatus changes its luminance in accordance with change of the data, and transmits the data to the handheld terminal in the form of visible light.

7. The computer according to claim 6, wherein the second backlight apparatus employs a light-emitting diode (LED) backlight source.

8. The computer according to claim 6, further comprising a photosensitive sensor configured to receive visible light data.

9. The computer according to claim 8, wherein the photosensitive sensor is disposed at an upper part of a border of the display screen of the computer.

10. A visible light communication system, comprising a handheld terminal and a computer,
wherein the handheld terminal is configured to perform data transmission with the computer and comprises a first backlight apparatus, a first control apparatus, a first data processing apparatus and a first data storage apparatus, wherein the first backlight apparatus is disposed on a display screen of the handheld terminal, the first data storage apparatus is stored with data, the first data processing apparatus accesses the data from the first data storage apparatus and converts the data to a plurality of luminance level control signals that are configured to control the luminance of the first backlight apparatus, the first control apparatus controls the first backlight apparatus to adjust its current luminance based on the plurality of luminance level control signals, and the first backlight apparatus changes its luminance in accordance with change of the data and transmits the data to the computer in the form of visible light; and
the computer is configured to perform data transmission with the handheld terminal and comprises a second backlight apparatus, a second control apparatus, a second data storage apparatus and a second data processing apparatus, wherein the second backlight apparatus is disposed on a display screen of the computer, the second data storage apparatus is configured to store data, the second data processing apparatus accesses and converts the data to a plurality of luminance level control signals that are used to control the luminance of the second backlight apparatus, the second control apparatus controls the second backlight apparatus to change its current luminance based on the plurality of luminance level control signals, and the second backlight apparatus changes its luminance in accordance with change of the data, and transmits the data to the handheld terminal in the form of visible light.

11. The visible light communication system according to claim 10, wherein the handheld terminal further comprises a visible light receiver configured to receive visible light data.

12. The visible light communication system according to claim 11, wherein the visible light receiver is disposed on a border of the display screen of the handheld terminal.

13. The visible light communication system according to claim 11, wherein the visible light receiver is disposed adjacent to a front camera of the handheld terminal and thus forms a combination with the front camera.

14. The visible light communication system according to claim 10, wherein the first backlight apparatus employs a light-emitting diode (LED) light source.

15. The visible light communication system according to claim 10, wherein the second backlight apparatus employs an LED backlight source.

16. The visible light communication system according to claim 10, wherein the computer further comprises a photosensitive sensor configured to receive visible light data.

17. The visible light communication system according to claim 16, wherein the photosensitive sensor is disposed at an upper part of a border of the display screen of the computer.

18. The handheld terminal according to claim 2, wherein the visible light receiver is a phototriode.

19. The handheld terminal according to claim 1, wherein the handheld terminal is a mobile phone.

20. The computer according to claim 8, wherein the photosensitive sensor is a phototriode.
